(19) United States
(12) Patent Application Publication
(10) Pub. No.: US 2015/0095336 A1
(43) Pub. Date: Apr. 2, 2015

(54) Geo-Spatial Asset Clustering

(71) Applicant: TRAC Rail Inc., London (CA)

(72) Inventors: Craig GREEN, London (CA); Jay POT, London (CA)

(21) Appl. No.: 14/499,021

(22) Filed: Sep. 26, 2014

Related U.S. Application Data
(60) Provisional application No. 61/883,371, filed on Sep. 27, 2013.

(51) Int. Cl. G06F 17/30; G01S 19/46; G01S 5/02

(52) U.S. Cl. CPC G06F 17/30713; G06F 17/30241; G01S 5/0263; G01S 19/46
USPC 707/737

(57) ABSTRACT

A system and method are provided for visualizing a site having at least one cluster of assets. The method comprises determining a location for an asset; determine at least one additional asset within a particular region, based on the location of the asset; determine a subset of assets to be analyzed, the subset including the asset; performing an asset clustering of the subset to create at least one cluster of assets; and providing an output with at least one cluster of assets.

This application claims priority from U.S. Provisional Patent Application No. 61/883,371 filed on Sep. 27, 2013, the contents of which are incorporated herein by reference.

### TECHNICAL FIELD

The following relates to systems and methods for geo-spatial asset clustering.

### BACKGROUND

Assets being utilized in various industrial or commercial capacities (e.g., construction, civil projects) typically need to be monitored in order to understand their utilization, performance, and location. Monitoring systems can be installed on an asset which provides the ability to monitor the asset's location and performance. This information can be analyzed and viewed by the other or a third party. Exemplary monitoring systems can include Global Positioning Systems (GPS) or cellular systems used to triangulate the location of the asset. Transmission systems such as cellular or satellite systems can be used to relay and transmit information regarding the asset.

Similarly, methods currently are in place for the setup and administration of work site locations in a machine to machine application (“M2M”); a work site comprising any region where particular type of work or application takes place. However, traditional systems have been found to have limitations, for example, they can be laborious and time consuming. For example, system administrators are typically required to create (e.g., ‘draw’) the geographical boundaries of each work site. This activity can be rather slow and inefficient as there can be a delay from the time that the asset arrives on the work site to the time an administrator defines the work site in the M2M application.

The following provides a system and method to address the above.

### SUMMARY

In one aspect, there is provided a method of visualizing a site having at least one cluster of assets, the method comprising: determining a location for an asset; determine at least one additional asset within a particular region, based on the location of the asset; determine a subset of assets to be analyzed, the subset including the asset; performing an asset clustering of the subset to create at least one cluster of assets; and providing an output incorporating the at least one cluster of assets.

In another aspect, there is provided a computer readable medium comprising computer executable instructions for visualizing a site having at least one cluster of assets, the computer readable medium comprising instructions for: determining a location for an asset; determine at least one additional asset within a particular region, based on the location of the asset; determine a subset of assets to be analyzed, the subset including the asset; performing an asset clustering of the subset to create at least one cluster of assets; and providing an output incorporating the at least one cluster of assets.

In yet another aspect, there is provided a system for visualizing a site having at least one cluster of assets, the system comprising at least one server device configured for: determining a location for an asset; determining at least one additional asset within a particular region, based on the location of the asset; determining a subset of assets to be analyzed, the subset including the asset; performing an asset clustering of the subset to create at least one cluster of assets; and providing an output incorporating the at least one cluster of assets.

### BRIEF DESCRIPTION OF THE DRAWINGS

Embodiments will now be described by way of example only with reference to the appended drawings wherein:

FIG. 1A is a block diagram showing an exemplary embodiment of a system architecture for implementing asset information allocation and reporting

FIG. 1B is a block diagram showing another exemplary embodiment of a system architecture for implementing asset information allocation and reporting

FIG. 2 is a block diagram showing exemplary components of the position tracking module; with on example embodiment

FIG. 3 is a block diagram showing a monitoring module, in accordance with an example embodiment;

FIG. 4 is a block diagram showing a monitoring system processor, in accordance with an example embodiment;

FIG. 5 is a block diagram showing a geospatial analysis system architecture, in accordance with an example embodiment;

FIG. 6 is a flow diagram showing a method for asset clustering, in accordance with an example embodiment;

FIG. 7 is a flow diagram illustrating data collection analysis and reporting, in accordance with an example embodiment;

FIG. 8 is a block diagram showing a plurality of reports, in accordance with an example embodiment;

FIG. 9 shows a clustering report, in accordance with an example embodiment; and

FIG. 10 shows a detailed report on asset parameters aggregated into clusters, in accordance with an example embodiment;

### DETAILED DESCRIPTION

It has been recognized that a system that is configured provide an efficient and dynamic way to consolidate remotely connected (e.g. mobile) assets into work site clusters, analyze data on the clusters, and be able to do so in real-time would be advantageous.

The following describes a system and method to provide dynamic consolidation of remotely connected, mobile assets into sites, done in real-time. Additionally, the utilization of each asset can be calculated and aggregated into a utilization value for the entire cluster. The cluster data (e.g., included assets, health and maintenance, utilization, etc.) is presented to end users through a communication device and its user interface.

In the following discussion, the assets contained within the sites (clusters) that are being monitored are typically portable pieces of construction equipment. For example, generators, compressors, aerial work platforms, light towers, etc. They are being consolidated so that interested parties can have a holistic view of the equipment at a work site. A cluster represents what the system believes to be a work site. Work sites are important to various constituents for the following reasons:

Field service technicians—when dispatched to provide service they can better plan their work by knowing if the asset can be taken out of commission and replaced by another one on site. It also allows them to identify any other work that they could perform while in the vicinity.

Job Forman—balance asset workload. Gives insight into how they can allocate assets to ensure that bottlenecks are not created by an unbalanced utilization of assets. Can also reduce job costs by removing unused assets from a site.

Rental Company—can provide additional services to customers by suggesting which equipment should be taken on and off rent.

GPS position is remotely transmitted to a back office analysis engine, as described below, where the position is evaluated and compared to the most recent GPS positions of other assets, e.g. by executing a clustering algorithm. It is this data point that is used to evaluate the cluster.

The clustering algorithm may be done at the gateway level as asset positions arrive. A global collection of assets can be analyzed to find density-based groupings of assets and each grouping saved as a “site”. As described below, the clustering may be performed by executing pre-filtering and scanning (e.g. DBSCAN) stages with post processing performed, and regions defined, thereafter.

It has also been recognized that run hour data is another data point (like GPS) that can be transmitted from the remote asset. For example, the number of hours that the asset has been running can form the “run hour data”, analogous to the odometer in a car. The run hour data can be used to determine how the asset is utilized on site. The real-time aspect is important, as it needs to be re-evaluated as equipment moves on/off of the job site. An algorithm described below uses statistical analysis and subsequent application in real-time based on the cluster results.

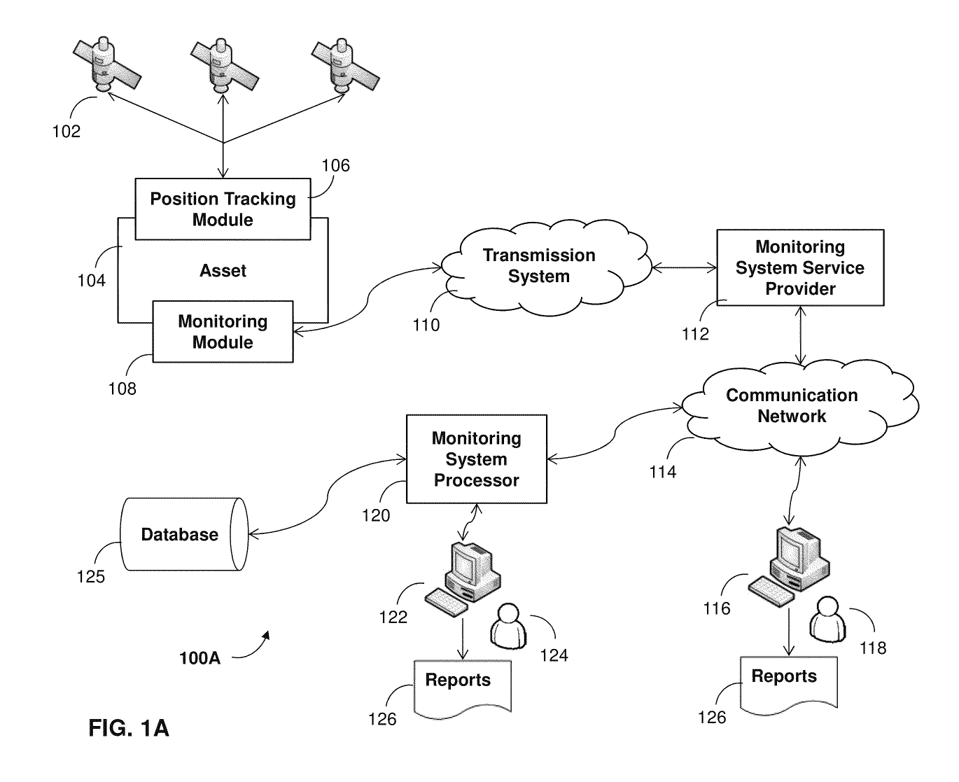

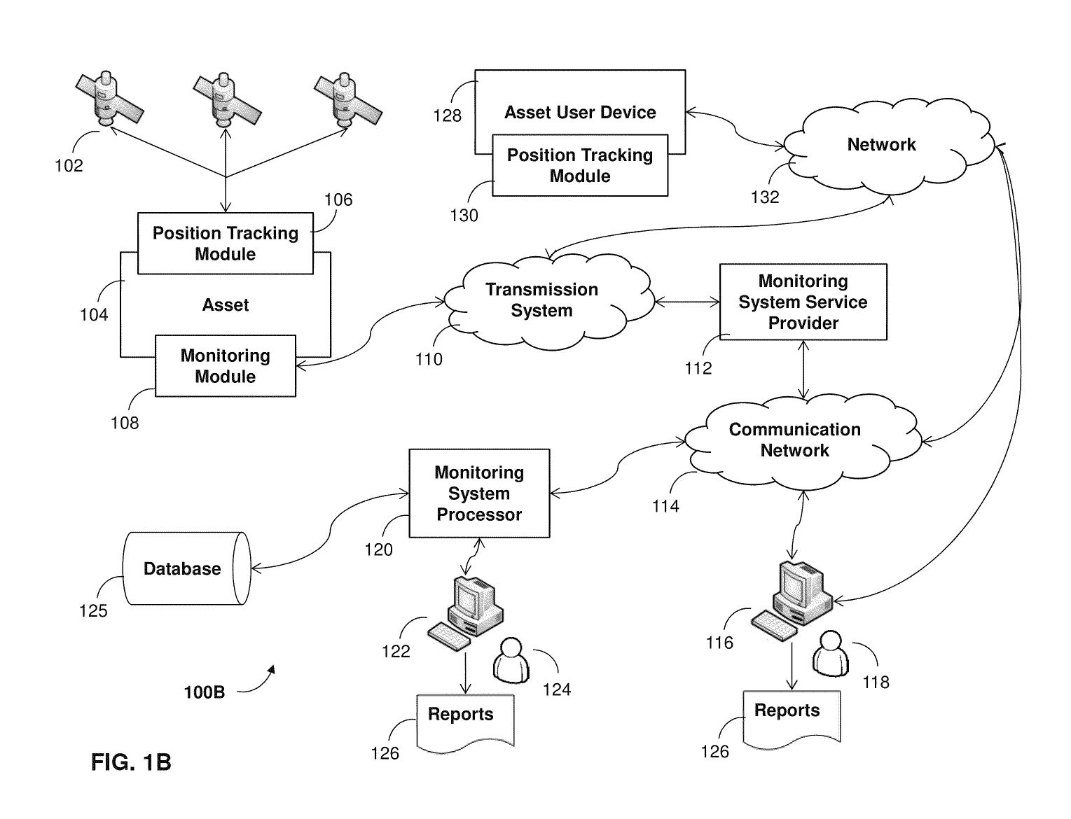

To illustrate an environment in which the above-noted clustering and geo-spatial analyses may be conducted and utilized, FIGS. 1-4 are now described.

FIG. 1A illustrates an example environment 100A, within which asset information reporting can be implemented. The example environment 100A comprises an asset 104, which can, in turn, include an installed position tracking module 106 and a monitoring module 108. The position tracking module can integrate a GPS transceiver to communicate with GPS satellites 102. The monitoring module 108 collects, stores, receives, (and possibly processes) and transmits various information related to the positional and operational data of the asset 104. The monitoring module 108 can communicate with the position tracking module 106 in order to monitor the position of the asset 104. The monitoring module 108 can also integrate a cellular/satellite transceiver, local wireless technology, and/or various computing technologies into a single mobile positioning and communication system. The monitoring module 108 can also include a GPS transceiver on its own, in another exemplary embodiment. The monitoring module 108 can send position coordinates, such as GPS data coordinates and sensor events, and messages from the asset 104 to monitoring system service provider 112 running software specifically designed to process this type of information. The monitoring module 108 processes information and make decisions on intelligent reporting of data that is to be collected and reported. The monitoring module 108 can also receive messages sent from the monitoring system service provider 112.

The environment 100A can include a transmission system 110. This transmission system can be utilized for transmitting and receiving positional and operational data to and from the monitoring module 108. The transmission system 110 in this example includes a satellite network and/or a cellular network. The transmission system 110 can also be a short range wireless network used by computer systems. Transmission system 110 can also receive and transmit the positional and operational data from a monitoring system service provider 112. The monitoring system service provider 112 may include dedicated circuitry or a general purpose computer configurable to make the information collected at the monitoring module 108 available through an open architecture interface, such as an Application Programming Interface (API). The environment 100 can also include a communications network 114. The network 114 can be a network of data processing nodes that are interconnected for the purpose of data communication (e.g., a global computer network, such as the Internet).

The monitoring system provider 112 is communicatively coupled to the network 114. A monitoring system processor 120, illustrated within the environment 100, can also be communicatively coupled to the network 114. The monitoring system processor 120 can be utilized to access and pull the positional and operational data associated with the asset 104 via the open architecture interface. Various communication protocols (e.g., Web Services) can be utilized in the communications occurring between the monitoring system processor 120 and the monitoring system service provider 112. The monitoring system service provider 112 can utilize telematics and intelligent data processing as well as software to make the information available via the network 114.

While illustrated as two separated systems, in an example, the monitoring module 108 and the monitoring system processor 120 can be integrated and communication between the two systems occur as an asset that is being monitored.

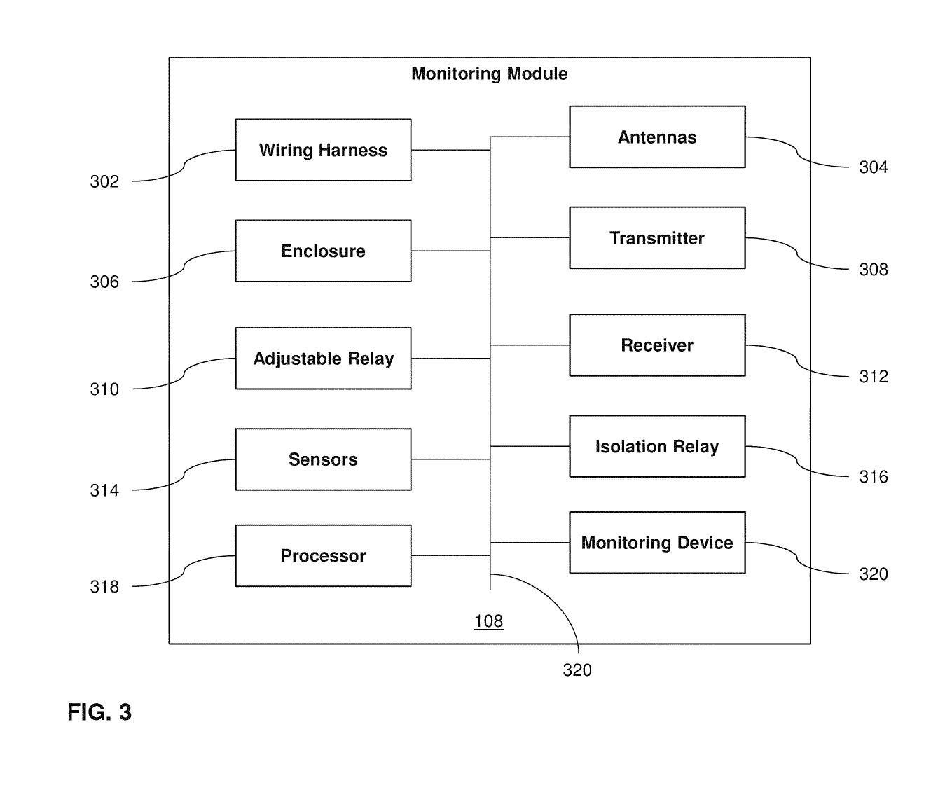

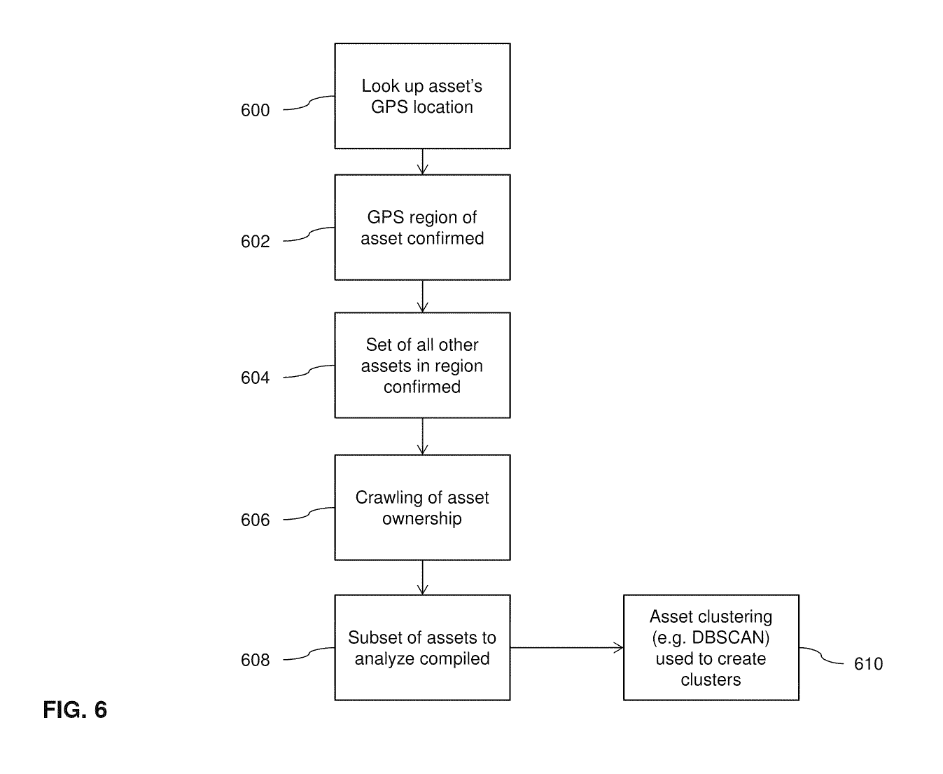

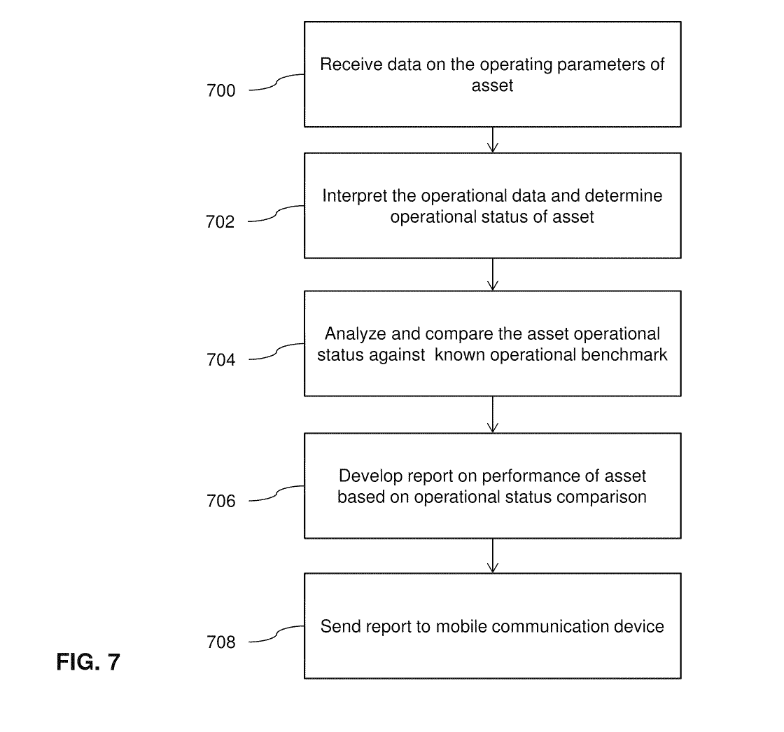

The monitoring system processor 120 can be communicatively coupled to a database 125, in which the monitoring system processor 120 may periodically store results after processing of the information received from the monitoring system provider 112. The monitoring system processor 120 can includes various modules, discussed in more detail below with reference to FIG. 3. The modules of the monitoring system processor 120 can be utilized to perform various operations discussed in more detail with reference to FIGS. 6 and 7.

The monitoring system processor 120 is optionally associated with an operator 124 operating the monitoring system processor 120 via a computer 122. The computer 122 can include a Graphical User Interface (GUI) facilitating display and manipulation of the monitoring system processor 120. The computer 122 can also enable the operator 124 to view and manipulate reports 126 that can be used to manage and monitor one or more of the assets associated with the authorized user. The monitor can be remote and the graphics being displayed can be over a computer network. A computer 122 is shown as an exemplary device for operating the monitoring system processor 120 in this particular embodiment; however, it can be appreciated that any device that can communicate instructions with a monitoring system processor 120 can be utilized in place of a computer 122. Devices such as a tablet computer, mobile phone, personal digital assistant, and/or laptops can be used for this purpose. The monitoring system processor 120 can also be housed on a cloud and accessed by any device that can act as a terminal with access to the cloud.

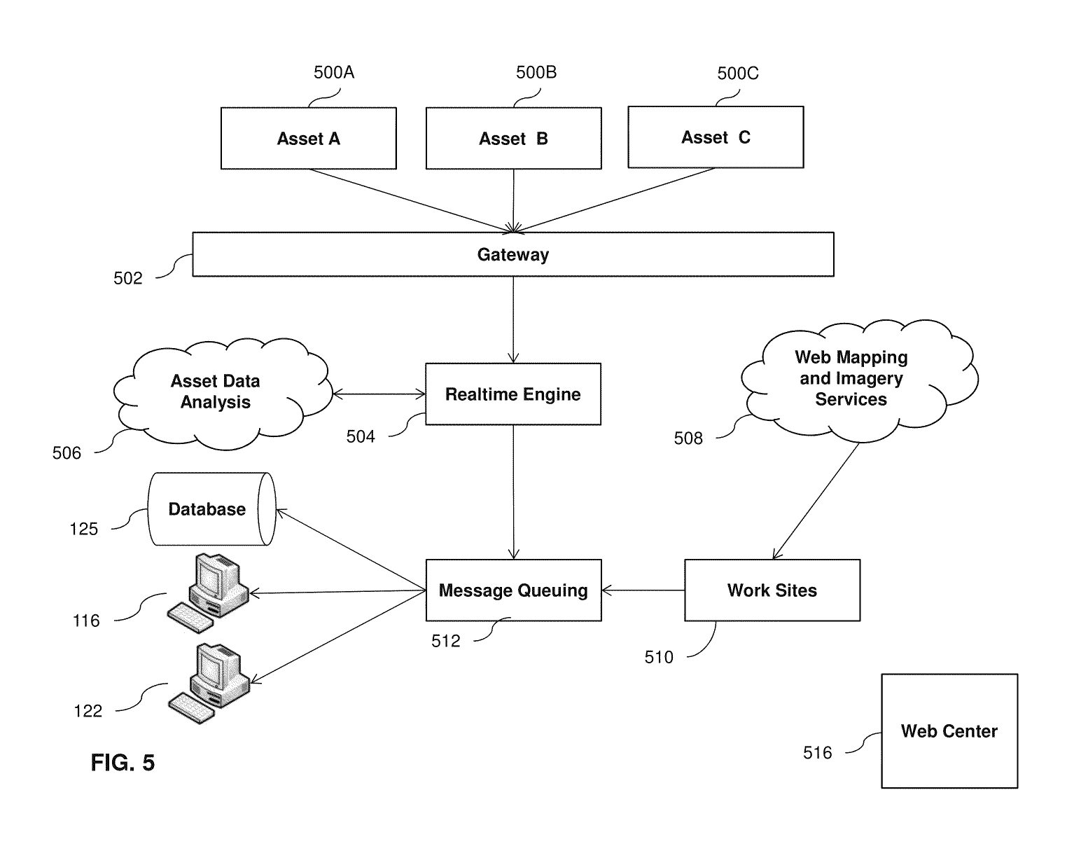

The authorized user can receive real-time reports related to the asset usage, performance, and location. Using detailed map views, the authorized user can see up-to-date data related to location of the asset 104. The reports 124 can include a production report. The production report, for example, can detail number of loads, cycle times, and amount of material moved by the asset 104. The reports 126 can include a utilization report. The utilization report, for example, can detail fuel efficiency, idle and working time of the asset 104. The reports 126 can also include a maintenance report. The maintenance report can include a record of the asset 104 maintenance history. The reports 126 can also include a health report. The health report can include the current health of the asset 104 by analyzing faults and alarms. These reports 126 can provide the data on a collection of individual assets 104 by combining them into clusters based upon their location, as discussed in relation to FIG. 5.

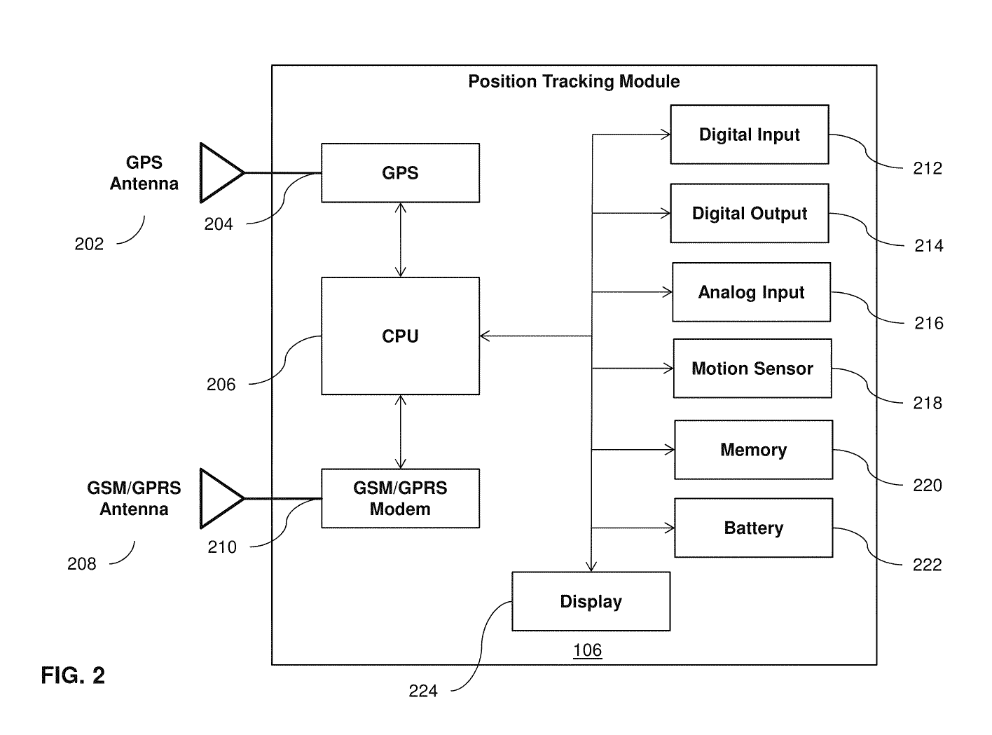

The monitoring system processor 120 can provide the reports 126 to an authorized user 118 via the communication network 114. The authorized user 118 can view the reports 126 using a general purpose computer 116 or any other device providing an ability to view the reports 126. In some example embodiments, the monitoring system processor 120 can send copies of the reports 126 to the authorized user 118 attached or embedded in a body of an electronic email. The reports 126 are based on the information initially provided by the monitoring module 108. The monitoring module 108 is described below, by way of example with reference to FIG. 2.

FIG. 1B is illustrates an example system 100B, within which asset information reporting can be implemented in a manner similar to that described herein with reference to FIG. 1A. However, environment 100B includes a further asset user device 128 that can sense and provide data associated with the asset 104, e.g. an embedded computer, coupled electronic device, integrated sensor, etc. The device 128 can provide the data to a network 132, which in turn can communicate the data to at least one of a transmission system 110, the monitoring system service provider 112, directly to a user computer 116, monitoring system processor 120 or the further communication network 114. In a further example, the device 128 stores data in its memory and then downloads the data when connected to a user device, e.g., when plugged into a user computer for synchronization or battery charging.

System 100B includes an asset device 128 that can provide additional data regarding the asset 104. Asset device 128 can be a mobile device that is physically separate from the asset 104 but can provide additional data regarding the asset. Asset device 128 can include its own position tracking module 130. For example, the asset device 128 can be the mobile phone of the asset operator. In this case the mobile-phone, asset device 128 can determine the location of the device 128 and report it through network 132, which can also include one of more of the communication network 114, the transmission system 110 in any of its embodiments, to at least one of the monitoring system service provider 112, the authorized user 118 through the general purpose computer 116 and the monitoring system processor 120. The additional data from the asset device 128 can be used to supplement the data used in processing the received data to produce reports.

The data collection device 128 can be an asset user electronic device that includes a processor and memory. The device 128 can sense or input data relating to the asset 128 for reporting performance and status of the asset. In an example, the device 128 includes a navigational positioning system that tracks the position of the device 128. During certain known times, the device 128 is closely associated with the asset as the operator/user is controlling the asset. The device 128 can then report positional data that can be used to evaluate the performance of the asset. The device 128 can run a program that stores its location at certain times. The time of the location data will also be stored to correlate the location data with operational data from the asset 104.

The device 128 can further execute instructions that provide a template or structured input box to prompt the user to input desired information that can be used to evaluate asset performance. In an example, certain predicted events can be part of the template. Examples of predicted events can be lunch breaks, arrival at a known location, loading event, unloading event, maintenance event, etc. Any data type can be input into the reporting system by the device 128.

The device 128 can further input data for reporting in an unstructured format. Any event or other data that a user believes to be important to the performance can be input from the device into the report system. The device 128 can communicate with other components of the reporting system using other electronic communications, e.g., email, text message, voice mail, etc. The additional data provided by the device 128 can be used to for maintenance tracking, asset mechanical status, asset electrical status, or other performance. The additional data can further document fluid checks or odometer readings. The additional data can also include images of the asset, for example, after an accident or mishap, or routine documentation of the asset according to contractual agreements, e.g., insurance agreement or rental agreement. The third party agreements can be implemented in an application, (i.e., stored and executable instructions), that requests the required data to be input by the user through the device 128.

In a further example, the device 128 can provide data relating to the asset to the user. The data provided to the device 128 can be parts lists, maintenance data, operating instructions, links to acquire reports, data, or templates, or other data. This data can be provided by the monitoring system provider 112 or the monitoring system processor 120 or from third parties through these environment components and communication networks.

The monitoring system provider 112 or processor 120 can filter and/or process the data into reports that can be provided to an end user or owner of the assets. The reports can be populated with data from the device 128 to provide a more robust report and automate asset reporting, maintenance, and other efficient reporting.

Data communication as described in FIGS. 1A and 1B couples the various devices together. The network 114 is preferably the Internet, but can be any network capable of communicating data between devices can be used with the present system. In addition to the Internet, suitable networks can also include or interface with any one or more of, for instance, an local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modern connection, a cable modem, an ATM (Asynchronous Transfer Mode) connection, or an FDDI (Fiber Distributed Data Interface) or CDDI (Copper Distributed Data Interface) connection. Furthermore, communications can also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The communication network 114 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. In an example, the network 132 can be capable of communicating using any one or a plurality of the above communication means discussed herein.

FIG. 2 is a block diagram showing the exemplary subcomponents of a position tracking module 106 The position tracking module 106 comprises a GPS antenna 202 which can interface with a built-in GPS component 204. The GPS component 204 transmits and receives location data through the GPS antenna 202 in order to communicate with GPS satellites. This communication is used to determine the location of the position tracking module 106. A CPU 206 processes the data from the GPS 204 and allows interfacing between the various subcomponents of the position tracking module 106. A GSM/GPRS modem 210 allows for communication with cellular networks to transmit and receive data (including but not limited to positional data) across the GSM and GPRS antenna 208. The GSM/GPRS modem 210 is connected to the CPU 206 for further processing of data.

The CPU 206 has connections to digital inputs 212 for interfacing with any digital device or a digital signal inputted into the position tracking module 106. Exemplary digital inputs can come from switch closures, relay contacts, or transistor-transistor logic interface signals. Similarly, a digital output 214 can send digital signals from the position tracking module 106. These digital signals can be received by any device or group of devices capable of receiving digital signals. An analog input 216 allows for the input analog of signals. Exemplary analog signals can include signals from transducers that can sense pressure and temperature. The signals inputted as analog can be converted to digital or vice versa, in order to make processing by the CPU 206 more efficient as desired. A motion sensor 218 is also present in the position tracking module. The motion sensor 218 can be used to ensure the tracking module 106 is safe and to sense any unexpected behavior in terms of motion for the position tracking module 106. Memory components 220 can be used to store any data received from the inputs or being processed by the CPU 206. Exemplary memory components include RAM, ROM, and/or flash storage. A battery 222 is used to power the position tracking module. The status of the battery 222 health and charge level can be monitored by the CPU 206. The battery can be either chargeable or rechargeable, with exemplary battery types comprising of Li-Ion, Alkaline, Ni—Li, NiMH, and NiCd among others. A display 224 can be used to interface with a user or viewer. The display 224 can include LED lights to indicate functionality and errors, or a screen such as LCD to display information regarding the position tracking module 106 and its subcomponents.

FIG. 3 is a block diagram showing a monitoring module 108, in accordance with an example embodiment. The monitoring module 108 can includes a wiring harness 302, an antenna 304, a transmitter 308, a receiver 312 an enclosure 306, an isolation relay 316, an adjustable relay 310, a monitoring device 320, sensor(s) 314, and processor(s) 318. The monitoring module 108 can be a stand-alone component utilized to determine and communicate asset status, which can include position, speed, and direction. The monitoring module 108 can also interface with the sensors 314 and external accessories as part of an on-board system that monitors asset's performance. Events being monitored include an ignition status, a distance moved since last valid loading or unloading event, a time elapsed since last valid loading or unloading event, a loading sensor “on” time and “off” time, an unloading sensor “on” time and “off” time.

The transmitter 308 and the receiver 312 are electrically connected to the antenna 304 for respectively sends in receiving over the air electromagnetic signals. The transmitter 308 includes electronic circuits to receive an input signal from the antenna 304. The transmitter 308 can include a power supply, an oscillator, a modulator, and amplifiers for specific frequencies. The modulator adds signal information onto a carrier frequency, which is then broadcast from the antenna 304. The receiver 312 can include electronic filters to separate a desired radio signal from noise and other signals sensed by the antenna 304. The receiver 312 amplifies the desired signal to a level suitable for further electronic processing, e.g., demodulation and decoding, and signal processing. While the transmitter 308 and the receiver 312 are shown as separate devices in FIG. 3, it will be recognized that a transceiver, a device that includes circuits for both sending and receiving is within the scope of the present disclosure.

The monitoring device 320 can include firmware, which supports automated monitoring, and reporting of the asset 104 activities and status. For example, the monitoring device 320 can detect an alert and cause the antenna 304 to send the alert to the monitoring system provider 112 The alert sent to the monitoring system provider 112 can be, in an example, accompanied by a location and operational data of the asset 104. Information related to other events can be detected, stored, and transmitted by the monitoring device 320. The monitoring device 320 can automatically report arrival or departure of the asset 104 from a job or home site location. The monitoring device 320 can also record and transmit various machine utilization parameters, such as a time and distance traveled. The monitoring device 320 can be mounted on the asset 104 and does not require operator access or involvement.

The monitoring device 320 can include processors that execute applications, which are instructions stored on computer readable media. The local processing capability of the monitoring can perform simple and complex logic, including but not limited to, power management, communication management, data storage, encrypted communication, and/or real time clock processing and management.

The wiring harness 302 includes, in an example, a string of cables and/or wires, which transmit electrical signals or operating currents between other components of the monitoring module 108. By binding wires and cables into a cable harness, the wires and cables are secured against the adverse effects of vibrations, abrasions, and moisture. By constricting the wires into a non-flexing bundle, usage of space is optimized and the risk of a short circuit is decreased. The wires bundled in the wiring harness 302 can be connected to various parts of the asset 104 to transmit various signals from sensors 314, activators (not shown), pumps (not shown), or other asset components to the monitoring module 108.

The sensor(s) 314 can be installed at various locations of the asset 104. The sensors 314 can measure loading and unloading operations associated with the assets such as excavators, haul trucks, loaders. To communicate the event to the monitoring device 320, the sensors 314 can also utilize short range radio communications protocol (e.g., IEEE 802.15.X, IEEE 802.15.4, or other short range wireless technologies). A sensor 314 can be a fuel air mixture sensor. A sensor 314 can monitor motor exhaust for various components of the exhaust gas. A sensor 314 can detect oil quality or oil pressure or time since last oil change. A sensor 314 can measure engine speed (rpm) or hours of operation. A sensor 314 can measure fuel level. Other fault detection can be sensed by sensor 314.

For example, in a scraper the wires can be utilized to transmit electrical signals when the apron opens and/or closes and ejector door extends and/or retracts. The wires can also be utilized to transmit signal back to the monitoring device 320 when, for example, the operator of the asset 104 engages various controls. Thus, the components of the monitoring module 108 can be combined to enable the transmission of GPS position data, events, alarms, and sensor inputs to the monitoring system provider 112 via a satellite and/or cellular network. Data can be stored by the monitoring module 108 for a period of time until a transmission can be made.

The sensor 314 can also be used to determine utilization of the asset. The sensor 314 can sense the movement of part of the asset. In an example, the part is different that the prime mover, e.g., a motor. The part can be a lift mechanism, an arm or other part that is not in a certain determinable position when the asset is in use. In an example, the sensor 314 can be a contact sensor that determines if part of the asset is not in a home or rest, i.e., non-utilization position. In a further example, the sensor senses when a person is on the asset, controlling the asset or at a specific location. The sensor 314 can be switch that must be activated by the user for the asset to work. When activated, the sensor 314 senses a utilization event.

The isolation relay 316 and the adjustable relay 310 can be utilized to regulate the information transmitted and received from the monitoring device 320. In some example embodiments, only the adjustable relay 310 is needed to provide a signal-to-ground contact closure while monitoring the transmission between the monitoring module 108 and the monitoring system provider 112.

The isolation relay 316 can allow a determination to be made as to whether the asset 104 is operational. All of the example components of the monitoring module 108 can be provided inside the enclosure 306. The enclosure 306 is, in an example, a metal housing that is sealed against dirt, grime, dust, and moisture that are generated at building construction sites, road construction sites, and in agriculture. It will be noted that the monitoring module 108 is not bound to a particular monitoring system provider. Any hardware that can successfully interface with the monitoring module 108 can be utilized as the monitoring system provider 112. The monitoring module 108 can, in some example embodiments, be specifically designed for the asset 104.

The processor(s) 318 operate to control various operations of the asset. In an example, the processor 318 is an electronic device to process received signals and output control signals to control operation of a component of the asset. An example of a processor 318 is an engine controller. Processors 318 can be microcontrollers and/or electronic control units (ECUs). Electronic control units can be made from programmable logic controllers and/or programmable gate arrays. In an example, a main processor 318 is provided and it controls other processors in a master/slave configurations. Processor(s) 318 can further operate without a master processor. In operation, the processor 318 receives a sensed signal from a sensor 314 regarding the operation of the asset. The processor 318 applies stored instructions to the sensed data and outputs a control signal to a component of the asset or stores the operational data in a memory.

A bus 320 provides a data communication path between the devices 302-318. In an example, bus 320 is a serial bus, e.g., Modbus or ethernet. The bus 320 can also be a controller area network, e.g., CAN-bus, CAN-open, SAE J1939 CAN-bus. A controller area network is a multi-master broadcast serial bus standard for connecting electronic control units (ECUs), such as a processor 318, to other electronic devices.

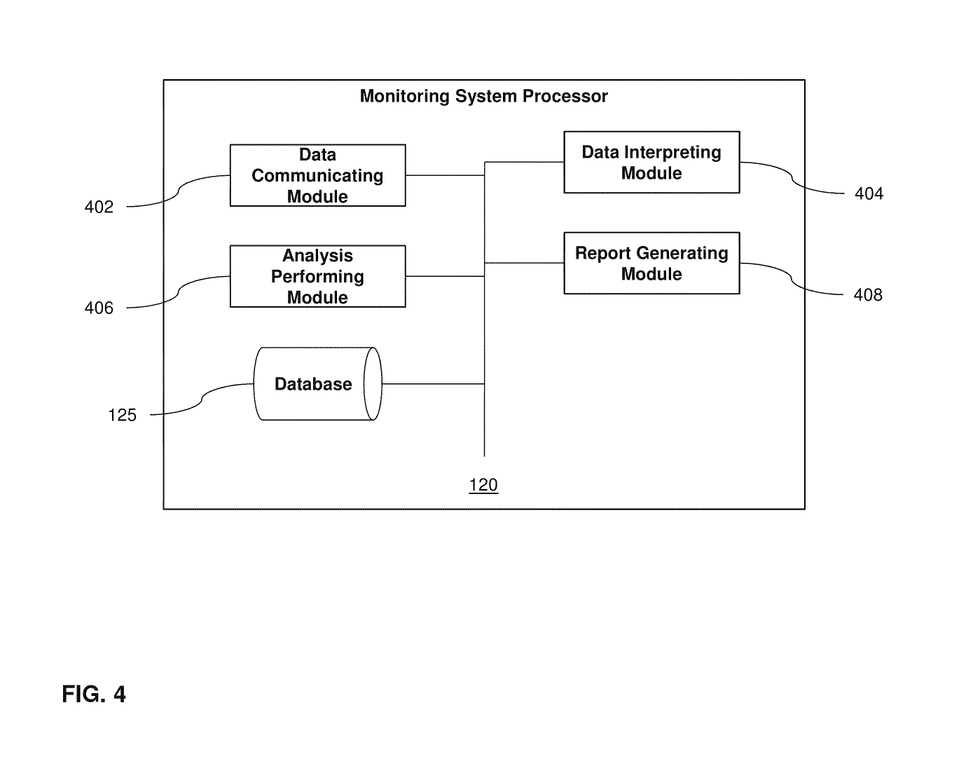

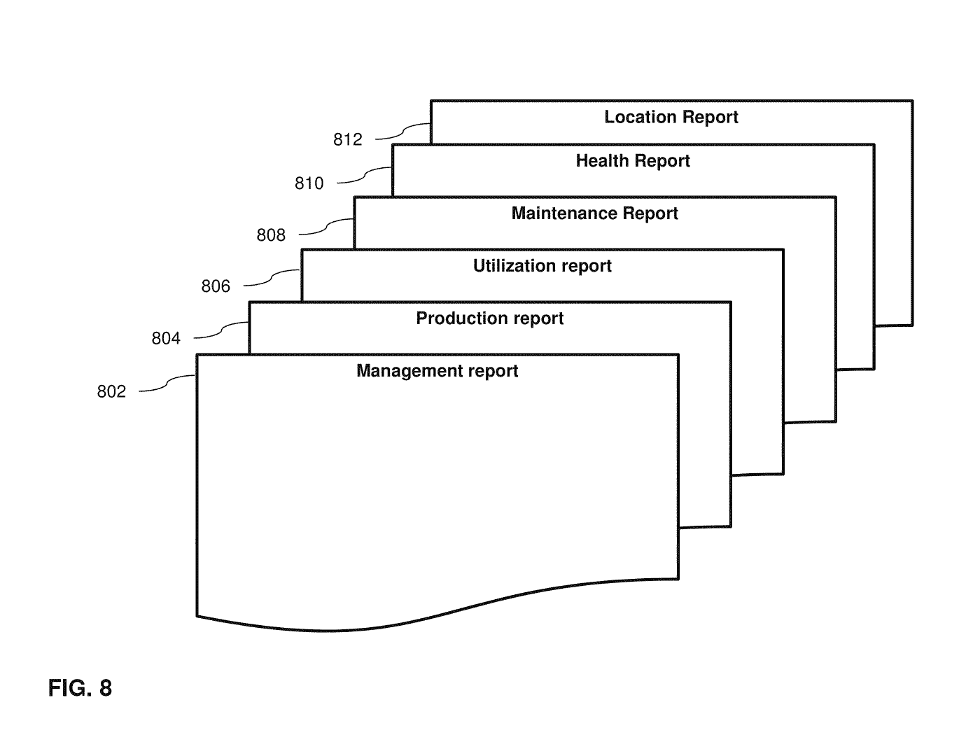

FIG. 4 is a block diagram showing a monitoring system processor 120, in accordance with an example embodiment. The monitoring system processor 120 can include, in some example embodiments, a data communication module 402, a data interpreting module 404, an analysis performing module 406, a report generator module 408, and the database 410. The operations of the modules and the monitoring system processor 120 are explained in more detail within the context of example methods for asset information reporting illustrated in FIGS. 7 and 8.

FIG. 5 is a block diagram showing the system architecture for analysis of asset location data to form a geospatial analysis. Assets 500A, 500B, and 500C, are present at their respective work site locations. The position of these assets is communicated through a gateway 502 to a real time engine 504. The gateway 502 can be any exemplary network set-up used to communicate data, for instance those shown in FIG. 1, such as network 132 or communication network 114 in the example embodiments provided. The real-time engine 504 can include any device or system capable of processing the data associated with the asset 104 in real-time. Example embodiments include those discussed as monitoring system processors 120 or an authorized computer 116. The real-time engine 504 can be stored on a local machine or operated through access to a cloud network. The real-time engine 504 has capabilities for asset data analysis 506, in particular analysis for data clustering, statistical analysis, and data aggregation. This analysis can be done locally at the real time engine 504, or by the ability for the real time engine 504 to interface with a cloud or other machine. While the examples described herein illustrate “real-time” operations, the principles can also be applied to non-real-time or near-real-time configurations.

Web mapping and imagery services 508 are used to create visualizations of work sites 510. Web mapping and imagery services 508 can include services such as Bing imagery services, Google maps services, or other mapping services available. The work sites 510 represent geographic locations. These locations can be determined by globally administrative areas, officially recognized geo-political regions, or custom regions defined for the purpose of the desired geospatial analysis. The work sites 510 can also be determined based on an ownership hierarchy to determine company or group administered locations. The instructions from the real-time engine and information regarding work sites can be housed in a message queue 512. The message queue 512 stores control messages or content until they are received by the receiving device. The message queue 512 can achieve this in the monitoring system processor 120 or even within the communication network 114 as shown in FIG. 1. In this particular embodiment, the receiving device is a database 126. The receiving device can also be a computer 116 or 122 as shown in FIG. 1.

FIG. 6 is a flowchart illustrating a process of clustering machines into work sites based on one example embodiment. The asset's positional data is determined at operation 600 using, for example, a GPS receiver. This can be done using the position tracking module 106, shown in FIG. 1. Using the data, the GPS region of the asset is confirmed. As discussed in relation to FIG. 5, regions include those defined as global administrative areas in this embodiment. When the region of the asset 104 (as shown in FIG. 1) is confirmed, all other assets present in the region are also determined at operation 604. This creates a set of assets present in the region. The assets are crawled for ownership at step 606 to determine which company or group the asset belongs to. At operation 608 all the information is compiled for analysis, exemplary information includes information on an asset's region, the set of assets in the region of the asset under consideration, and ownership information regarding the asset. This data is then processed using a clustering algorithm such as DBSCAN to form clusters/work sites at operation 610.

One example of a clustering algorithm that may be used will now be described. The clustering analysis may be done at the gateway level as asset positions arrive. A global collection of assets can be analyzed to find density-based groupings of assets, and each grouping may be saved as a “site”. An example of such processing is below.

Stage 1: Pre-Filtering:

The first stage of processing is to compute the subset of assets (out of the entire global collection of assets) that are affected by the asset currently being processed. 1) An asset's GPS coordinate is used to lookup its region (described below, see “Regions (Geo-political)”). 2) The set of assets currently also residing within that region are determined (e.g., by performing a look up) and a hierarchy is traversed by visiting each company and group once, in breadth-first traversal. At each iteration, the set of assets found as direct “children” of the company/group are intersected with the set retrieved in 2), and at this point the subset of assets to analyze is obtained. It may be noted that after Stage 2 (described below) is complete, the next iteration of Stage 1 begins.

Stage 2: DBSCAN:

A core clustering algorithm that may be used is DBSCAN. There are two kinds of points in a cluster, points inside of the cluster (core points) and points on the border of the cluster (border points). To find a cluster, DBSCAN starts with an arbitrary point p from the dataset and retrieves all points density-reachable from p with respect to an epsilon (Eps) and MinFts value. If p is a core point, this procedure yields a cluster. If p is a border point, no points are density-reachable from p and DBSCAN visits the next point of the dataset.

The following pseudo code illustrates an example DBSCAN:

DBSCAN (SefOfPoints, Eps, MinPts)

// SetOfPoints is UNCLASSIFIED
ClusterId := nextId(NOISE);
FOR Point in SetOfPoints DO

IF Point.ClusterId equals UNCLASSIFIED THEN

IF ExpandCluster(SetOfPoints, Point, ClusterId, Eps,

MinPts) THEN

ClusterId := nextId(ClusterId)

END IF

END IF

END FOR

END; // DBSCAN

ExpandCluster

The ExpandCluster function is an important step in the DBSCAN algorithm. It functions to expand from a single point to find further core points, and assigns each point a cluster identifier to distinguish it from a border point as follows:

ExpandCluster(SetOfPoints, Point, ClusterId, Eps, MinPts) : Boolean;

seeds := GetNeighbors(SetOfPoints, Point, Eps);
IF seeds.size < MinPts THEN // no core point

Point.ClusterId := NOISE;
RETURN False;

ELSE // all points in seeds are density-reachable from Point

setCluserIds(seeds, ClusterId); // iterates seed
seeds.delete(Point);
WHILE seeds <> Empty DO

currentP := seeds.first( );
result := GetNeighbors(SetOfPoints, currentP, Eps);
IF result.size >= MinPts THEN

FOR resultP in result DO

IF resultP.ClusterId IN {UNCLASSIFIED,

NOISE} THEN

IF resultP.ClusterId = UNCLASSIFIED

THEN

seeds. append(resultP);

END IF;

resultP.ClusterId := ClusterId;
END IF; // UNCLASSIFIED or NOISE

END FOR;

END IF; // result.size >= MinPts
seeds.delete(currentP);

END WHILE; // seeds <> Empty
RETURN True;

END IF

END; // ExpandCluster

SetOfPoints is the subset assets from the iteration in stage 1. Eps is the maximum distance in meters allowed to consider an asset a “neighbour” of another asset. It is determined based on the following heuristic:

IF SetOfPoints.size>=200 THEN Eps:=1250//1,250 meters

IF SetOfPoints.size>=400 THEN Eps:=1500

ELSE Eps:=1000

This accounts for large to very large fleets spanning greater distances geo-spatially. MinPts is always 3 (IE we will never consider a cluster of 2 or less).

GetNeighbors:

The GetNeighbors function returns the set points in SetOfPoints that are the “Eps-Neighbors” of Point.

Specifically, if the spherical distance in meters between Point and a point P′ in SetOfPoints is less than or equal to Eps P′ is included in the returned set.

Post-Processing:

1) After the density-based sets of assets are determined, each set is saved as a “Job Site” object with the following additional attributes:

Geo-political region used in the iteration; and

Hierarchy location (company or group) used in the iteration.

The Site is considered “new” if there is no other site in the region with a matching attribute for 2), and the same set of assets. New sites are saved to storage.

2) Each saved Site is given a centroid coordinate via a simple “containing rectangle” center point determination. This center point is passed to a 3^{rd} post-processing unit for further augmentation of the Site object (NodeJS):
satellite imagery is looked up for the coordinate. For example, the BING Maps Imagery service can be used for this purpose.
the coordinate is reverse geocoded to a likely “place name” using the Google Places API.

Regions (Geo-Political):

A database of geo-political world “regions” can be derived from the datum files at “http://www.gadm.org” and customized specifically for the processing described in “Stage 1: Pre-filtering”. The datum files contains 379 “global administrative areas” (GADM) with their geo-spatial shape:

With the exception of Australia, Canada, Mexico, Netherlands, and the United States, all countries/territories as defined in “GADM Level 0” are included. This accounts for 258 regions of the total dataset. Australia, Canada, Mexico, Netherlands and the United States as defined by their subdivisions in “GADM Level 1” are included. This accounts for 121 regions of the total dataset.

FIG. 7 is a process flow diagram illustrating a method for asset information in accordance with an example embodiment. The method can be performed by processing logic that can comprise hardware (e.g., dedicated logic, programmable logic, microcode, etc.), software (such as software run on a general purpose computer system or a dedicated machine), or a combination of both. In one example embodiment, the processing logic resides at the monitoring system processor 120, illustrated in FIG. 4. The method process depicted in FIG. 7 can be performed by the various modules discussed above with reference to FIG. 4. Each of these modules can comprise processing logic.

As shown in FIG. 7, the process commences at operation 700 with the data communication module 402 receiving data related to the operation of the asset 104. The data received by the communication module 402 can include the positional and operational data associated with the asset 104. The positional data can be obtained using the position navigation system, e.g., Global Positioning System (GPS), or a cellular triangulation system by the position tracking module 106 installed on the asset 104 and transmitted to the monitoring system provider 112. The positional and the operational data can be made available over a network from the monitoring system service provider 112 using an appropriate protocol (e.g., Web Services).

Examples of operational data include, but are not limited to, velocity, direction, an ignition key ON event, an ignition key OFF event, a door open event, a door closed event, a location, a fuel efficiency (e.g., fuel burn calculation), an idle time, a production statistics, a preventive maintenance schedule, a maintenance history, a cycle time, a utilization time period, a fault data, and an alarm data. The positional and the operational data can be received via a transmission system 110 at the monitoring system service provider 112 and then pulled by the monitoring system processor 120.

In some examples described above information may not be able to be transmitted immediately from the monitoring module 108 to the monitoring system service provider 112 due to, for example, a temporary unavailability of a satellite and/or the cellular network which comprises the transmission system 110. The monitoring module 108 can store information until communication over one of the networks between the monitoring module 108 and the monitoring system service provider 112 is restored. If the communication is disrupted due to the asset 104 moving out of the coverage area, the monitoring module 108 can be removed from the asset 104 and brought back into the coverage area. Alternatively, the asset 104 can be moved into the coverage area. Once the communications are restored, the monitoring module 108 can transmit information to the monitoring system service provider 112.

At operation 704, the data interpreting module 404 of the monitoring system processor 120 can interpret the positional data in view of the operational data to accurately determine characteristics of the asset 104. At operation 706, the data interpreting module 404 of the monitoring system processor 120 can perform analysis of the operational characteristic in view of a stored target to produce a performance output.

The stored target can be related to the asset 104 and/or to a site specific data related. In some example embodiments, a relationship between the performance output and the site specific data can be included in the reports 126.

The data interpreting module 404 of the monitoring system processor 120 can intelligently interpret the positional data of the asset 104 in view of the operational data. Any event having a low probability of occurring in view of the positional data associated with the asset 104 or in view of one or more of other events occurring in the same or nearly the same time, can be eliminated as false. For example, the data analyzing module 406 can determine that at the time of the reported loading event, the asset 104 was not operational or operational for a period of time which is too short for the loading to occur.

Thus, the reported loading event can be eliminate as false, if the data related to the ignition status shows that the asset was still in the warm-up phase. In another example embodiment, the data analyzing module 406 can compare the performance data of the asset to the positional data to determine whether, at the time of the reported events, the asset was present at the respective job site. If the asset was not present at the respective job site, the reported event can be eliminated as false. In some example embodiments, the data analyzing module 406 can analyze the performance data to ensure that each loading event is followed by an unloading event and vice versa.

In some example embodiments, invalid loading events can also be eliminated when a determination is made by the data analyzing module 406 comparing the performance data of the asset to the positional data, that asset has not moved between two events. Furthermore, invalid loading events can also be eliminated when the analyzing module 406 determines that the time period elapsed between the consecutive loading events is less than a predetermined time period.

It will be understood that various filter values can be associated with particular events and particular type and location of the asset. The filters can be adjusted by a user per each different asset. It will be further understood, that operators of the monitoring system processor 120 or a customer can be provided with an ability to set other criteria to intelligently analyze performance data of the asset 104. The information can be processed and sent for interpretations and analysis in near real-time.

At operation 706, a report generating module 408 of the monitoring system processor 120 can provide a report that includes the operational characteristic and the performance output, along with data regarding the work sites and clusters for assets. In some example embodiments, the report can be accessed by an authorized user via a computer interface. In some other example embodiments a digital copy of the report can be sent to a predetermined user via an electronic message (e.g., email, text message, etc.). The report can summarize the performance output of the asset 104 or be related to a specific area of operational characteristics. For example, the report can be related to production data associated with the asset 104.

At operation 708 the reports are sent to communications devices in order to be viewed and analyzed by users. The report related to the production data can include, but is not limited to, cycle times, number of loads, an amount of material moved, time of operation, and costs associated with the asset 104. The report can be related to utilization data associated with the asset. The report related to the utilization data can include an idle time, an amount of fuel consumed and an amount of fuel remaining in the asset. The report can be related to maintenance data associated with the asset. The report related to the maintenance data can include a date of an upcoming service, a type of the upcoming service, a location of the asset, and a part associated with the upcoming service. The report can also be related to health data associated with the asset. The report related to the health data associated with the asset can include an alarm and a fault associated with the asset 104.

Databases, stored at either at the operator's computer 126 or the authorized user's computer 116, as well as the monitoring system database 125 can store the reports generated according to the methods and systems described herein. The databases are stored on tangible computer readable media, such are magnetic media, electronic storage devices, optical storage devices, etc.

FIG. 8 is a block diagram showing a plurality of reports that can be generated for the asset 104 and/or the asset user device 128. These reports can include a management report 802, a production report 804, a utilization report 806, a maintenance report 808, a health report 810, and a location report 812. The management report 802 can represent a high-level overview of information for each site associated with one or more of the respective asset 104. The management report 802 can summarize the information available in one or more of other report types, such as the production report 804, the utilization report 806, the maintenance report 806, the health report 810, and/or the location report 812. In some example embodiments the management report 802 can combine essential data from the above-mentioned reports and provides it in an overview format.

The production report 804 can include cycle times, number of loads per day, amount of the material moved each day, machine hours, and machine costs. An aggregated site view of the data can also be generated. For example, the production report 804 could identify sites (vs. assets) that have over/under utilized assets.

The utilization report 808 can include the last time the machine was used, how frequently the machine is used and if possible to track the user, the frequency at which operator is operating the machine. The maintenance report 810 can include machine hours, timing of scheduled services, types of scheduled services, location of the asset, details of the scheduled services (e.g., maintenance operations, parts required, etc.). The health report 810 can include machine performance indicators, information on any alarms that have been triggered, or any other issues with the asset 104. The location report 812 can include information on the clustering data regarding the machine. It can aggregate the data regarding the location of an asset 104 and provide information regarding other assets in its work site, as determined by its location.

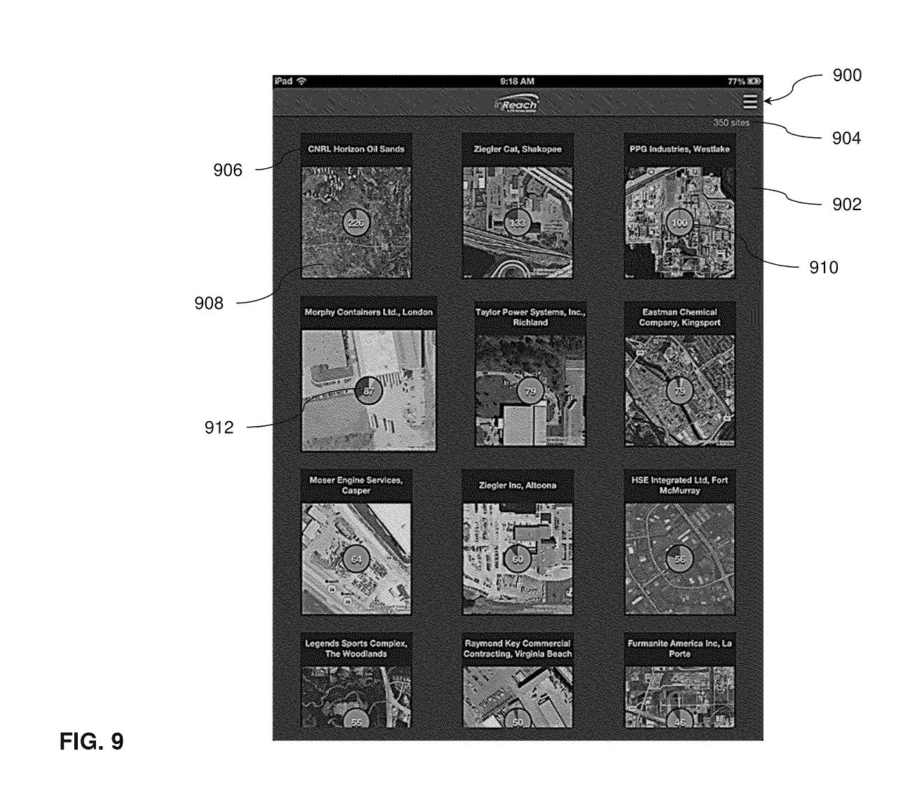

FIG. 9 shows an exemplary user interface screen 902 in one embodiment, on a tablet computer device 900. Information regarding work sites and clusters is displayed. A user is able to view the number of work sites present at 904. Each work site region is displayed with the name 906 of the work site. An aerial image of the work site 908 is present to show what a portion or entire work site looks like. This image can be acquired by a third party database or can be stored on the device 900. A numeric representation 910 of the number of machines present in the work site is available. In one exemplary embodiment, the portion of machines in their respective states can be displayed using a pie chart graphic 912. The graphic 912 can update in real time to represent the most accurate status of the machines. Machines in states that require high alert can be shown in the red portion of the pie while those who might require attention soon can be shown in yellow, those not requiring any immediate attention can be shown in green; in one exemplary embodiment. These alerts can represent machines that require servicing, are being over and/or under-utilized; or any other alerts as configured.

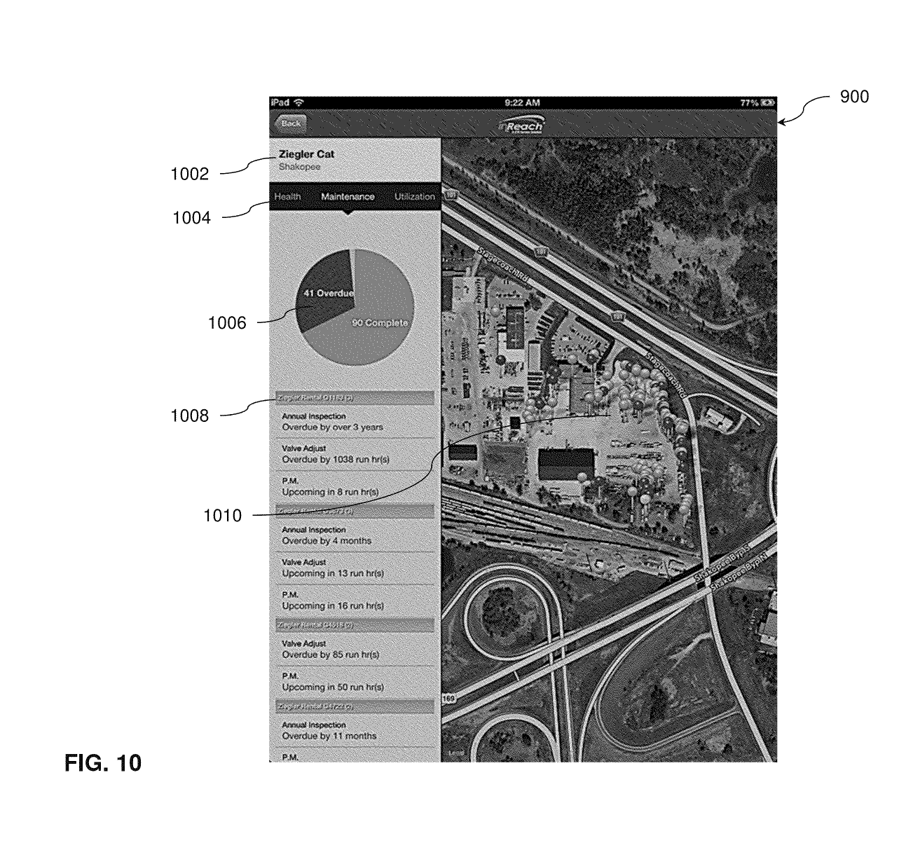

FIG. 10 shows a more detailed user interface on the device 900. The detailed interface screen can display the name of the work site at 1002. The user can select from the different reports available at the device by selecting whichever one is necessary at 1004. These reports can include but are not limited those described in FIG. 8. A graphic showing the portion of machines in each state of alert is also present at 1006. The user can get details regarding the states of each machine in a list 1008. The map also shows the physical location of each machine, depicted as a point of interest on 1010 on the map. The indicator can be a balloon as seen in this exemplary embodiment or another indicator as configured.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the gateway 502, asset data analysis 506, realtime engine 504, message queuing 512, work sites 510, web center 516, web mapping and imagery services 508, etc.; any component of or related thereto, or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of visualizing a site having at least one cluster of assets, the method comprising:
determining a location for an asset;
determine at least one additional asset within a particular region, based on the location of the asset;
determine a subset of assets to be analyzed, the subset including the asset;
performing an asset clustering of the subset to create at least one cluster of assets; and
providing an output incorporating the at least one cluster of assets.

2. The method of claim 1, wherein providing the output comprises displaying the at least one cluster of assets in a user interface.

3. The method of claim 1, wherein providing the output comprises providing a report.

4. The method of claim 1, wherein the particular region is determined using datum files defining global administrative areas.

5. The method of claim 1, wherein the subset of assets is determined based on ownership data associated with the at least one additional asset within the particular region.

6. The method of claim 1, wherein the asset clustering comprises:
performing a pre-filtering to determine the subset of assets by traversing a hierarchy of assets associated with a particular group or company;
performing a DBSCAN to find a cluster; and
performing post-processing to generate the output.

7. The method of claim 6, wherein the DBSCAN comprises an ExpandCluster function to expand from a single point to find further core points.

8. The method of claim 6, wherein the DBSCAN begins with an arbitrary point and retrieves all points density-reachable from the arbitrary point with respect to an epsilon and minimum points value.

9. The method of claim 2, wherein the user interface combines imagery data and markers illustrating locations of the at least one asset in the cluster.

10. The method of claim 1, wherein the location is determined from global positioning system (GPS) data received from the asset.

11. A computer readable medium comprising computer executable instructions for visualizing a site having at least one cluster of assets, the computer readable medium comprising instructions for:
determining a location for an asset;
determine at least one additional asset within a particular region, based on the location of the asset;
determine a subset of assets to be analyzed, the subset including the asset;
performing an asset clustering of the subset to create at least one cluster of assets; and
providing an output incorporating the at least one cluster of assets.

12. The computer readable medium of claim 11, wherein providing the output comprises displaying the at least one cluster of assets in a user interface.

13. The computer readable medium of claim 11, wherein providing the output comprises providing a report.

14. The computer readable medium of claim 11, wherein the particular region is determined using datum files defining global administrative areas.

15. The computer readable medium of claim 11, wherein the subset of assets is determined based on ownership data associated with the at least one additional asset within the particular region.

16. The computer readable medium of claim 11, wherein the asset clustering comprises:
performing a pre-filtering to determine the subset of assets by traversing a hierarchy of assets associated with a particular group or company;
performing a DBSCAN to find a cluster; and
performing post-processing to generate the output.

17. The computer readable medium of claim 16, wherein the DBSCAN comprises an ExpandCluster function to expand from a single point to find further core points.

18. The computer readable medium of claim 16, wherein the DBSCAN begins with an arbitrary point and retrieves all points density-reachable from the arbitrary point with respect to an epsilon and minimum points value.

19. The computer readable medium of claim 12, wherein the user interface combines imagery data and markers illustrating locations of the at least one asset in the cluster.

20. The computer readable medium of claim 11, wherein the location is determined from global positioning system (GPS) data received from the asset.

21. A system for visualizing a site having at least one cluster of assets, the system comprising at least one server device configured for:
determining a location for an asset;
determine at least one additional asset within a particular region, based on the location of the asset;
determine a subset of assets to be analyzed, the subset including the asset;
performing an asset clustering of the subset to create at least one cluster of assets; and
providing an output incorporating the at least one cluster of assets.
